(19) United States
(12) Patent Application Publication
(10) Pub. No.: US 2019/0015962 A1
(43) Pub. Date: Jan. 17, 2019

(54) LOCKING DEVICE FOR SPINDLE OF ELECTRIC TOOL

(71) Applicant: Best Select Industrial (SuZhou) Co., Ltd, Suzhou City (CN)

(72) Inventors: Qiang WANG, Suzhou City (CN); Hsi-Jen JEN, Suzhou City (CN); Yi-Tung CHIU, Suzhou City (CN)

(21) Appl. No.: 15/702,466

(22) Filed: Sep. 12, 2017

(30) Foreign Application Priority Data
Jul. 17, 2017 (CN) 201710580998.0

(51) Int. Cl. B25F 5/00; B25F 5/02

(52) U.S. Cl. CPC B25F 5/001; B25B 21/00; B25F 5/02

(57) ABSTRACT

A locking device for a spindle of an electric tool comprises an output shaft, a fixing ring, a retainer, locking roller pins, bearing roller pins and a power output disc. When the power output disc is active, the power output disc drives the output shaft to rotate thus outputting torque and meanwhile driving the retainer to rotate synchronously; when the output shaft is active, the output shaft rotates to make the planes of the multi-surface shaft of the output shaft deflect and drives the locking roller pins to abut against the fixing ring so as to lock the spindle. In the locking process, under the supporting effect of the bearing roller pins, the spindle rotates in a balanced mode and is stressed uniformly, the locking reliability is high, and the overall structure assembling difficulty is low.

### BACKGROUND OF THE INVENTION

### Technical Field

The invention relates to the technical field of electric tools, in particular to a locking device for a spindle of an electric tool.

### Description of Related Art

Electric tools are generally driven by electric power and include plugging-in electric tools, charging electric tools, charging and plugging-in dual-use electric tools and the like, the electric tools can clamp drill bits for drilling or clamp screwdrivers for mounting and dismounting screws. The charging electric tools can fail to drive the drill bits or the screwdrivers to rotate due to insufficient electric power and cannot be charged instantly for use; the plugging-in drill bits cannot be used when sudden power failures occur, and thus electric tools need to serve as manual drills.

According to the structure of the electric tool, a motor driving shaft is driven to rotate by combining a driving gear with the motor driving shaft to be directly engaged with a gear set and then engaging the gear set with a driven gear combined with a spindle; when the electric tool used as a manual drill is stressed to rotate, for solving the problem that the drill bit or the screwdriver idles in situ due to the fact that the driven gear driving a driving gear combined with the motor driving shaft through transmission of the gear set becomes the driving gear, the structure that a plurality of balls are arranged on the inner circle of a fixing ring to make contact with the side face of the spindle is available in the prior art, and the spindle drives the balls to abut against the fixing ring so as to be locked when power output is stopped and the spindle is active. However, by adoption of the structure, due to the factors such as the machining precision of the spindle and the concentric assembling errors between the spindle and the fixing ring, it cannot be ensured that all the balls are stressed evenly, the locking reliability is low, and noise can be generated when the spindle drives the balls.

A Mute Spindle Locking device disclosed by the Taiwan patent M275914 and a Gapless Spindle Locking Device disclosed by the Taiwan patent M383473 aim for solving the noise problem, the key lies in that an elastic retention mechanism being arranged on the inner circle of a fixing ring, an elastic part which can deform elastically is arranged in the radial direction of the balls, a buffer force is provided through elastic deformation of the elastic part, and thus noise is eliminated. However, the structure has the problems that the structure is complex, the assembling requirement is high, and the structure reliability is lowered when the elastic part deforms plastically due to the factors such as service fatigue.

### BRIEF SUMMARY OF THE INVENTION

On this basis, for solving the above problems, it is necessary to provide a locking device for a spindle of an electric tool, which is low in assembling difficulty and high in service reliability.

A locking device for a spindle of an electric tool comprises:

an output shaft, wherein the output shaft is provided with a multi-surface shaft with the outer-diameter portion being polygonal on the whole, every two adjacent planes of the multi-surface shaft are connected through arc surfaces of the same circumference, and the arc surfaces are concentric with the output shaft;

a fixing ring, wherein the fixing ring is fixedly connected to an electric tool shell and provided with a round through hole;

a retainer, wherein the retainer is arranged in the round through hole of the fixing ring and provided with an axial through hole allowing the multi-surface shaft to be inserted therein, first slots are formed in the positions, corresponding to the outer-diameter planes of the multi-surface shaft, of the wall of the axial through hole of the retainer, second slots are formed in the positions, corresponding to the outer-diameter arc surfaces of the multi-surface shaft, of the wall of the axial through hole, and insertion grooves are formed in the end face of the retainer;

locking roller pins, wherein the locking roller pins are contained in the first slots and assembled between the outer-diameter planes of the multi-surface shaft and the inner wall of the round through hole of the fixing ring in a spaced mode;

bearing roller pins, wherein the bearing roller pins are contained in the second slots and are in bearing fit with the outer-diameter arc surfaces of the multi-surface shaft and the round through hole of the fixing ring;

and a power output disc, wherein the power output disc is connected to an electric tool power system and provided with a center hole, sectorial convex parts are arranged in the positions, corresponding to the outer-diameter planes of the multi-surface shaft, of the inner wall of the center hole in a protruding mode in the radial direction, convex columns are arranged the end face, right facing the retainer, of the power output disc in a protruding mode in the axial direction, and the convex columns are matched with the insertion grooves of the retainer.

In an embodiment, when the power output disc rotates automatically until the sectorial convex parts abut against the outer-diameter planes of the multi-surface shaft to drive the output shaft, the maximum rotation angle of the power output disc relative to the output shaft is A; when the power output disc rotates automatically until the convex columns abut against the side walls of the insertion grooves of the retainer to drive the retainer, the maximum rotation angle of the power output disc relative to the retainer is B; when the output shaft actively rotates until the outer-diameter planes of the multi-surface shaft squeeze the locking roller pins onto the fixing ring to be locked, the maximum rotation angle of the output shaft relative to the fixing ring is C; half of the arc angle of each outer-diameter arc surface of the multi-surface shaft is D; A<(B+C), C<(A+B), and A<D.

In an embodiment, the angle A is equal to the angle B.

In an embodiment, the sum of the radius of the multi-surface shaft and the diameter of each bearing roller pin is not smaller than the sum of the distance from each outer-diameter plane to the center of the multi-surface shaft and the diameter of each self-locking roller pin.

In an embodiment, the ratio of the section circumferential radius of the multi-surface shaft to the radius of each bearing roller pin is not smaller than 2.5:1.

In an embodiment, the number of the outer-diameter planes of the multi-surface shaft is an even number.

In an embodiment, the number of the outer-diameter planes of the multi-surface shaft is four, and the arc angle of each outer-diameter arc surface of the multi-surface shaft is smaller than 45 degrees and larger than 20 degrees.

In an embodiment, the retainer is in interference fit with the fixing ring and is in clearance fit with the output shaft.

In an embodiment, the insertion grooves are formed in the ends, right facing the power output disc, of the first slots and/or the second slots.

In an embodiment, the width of each insertion groove is not smaller than the diameter of the corresponding first slot or the corresponding second slot.

According to the locking device for the spindle of the electric tool, when the power output disc is active, the sectorial convex parts of the power output disc abut against the planes of the multi-surface shaft to drive the output shaft to rotate so as to output torque, meanwhile, the convex columns of the power output disc are matched with the insertion grooves in an inserted mode so as to drive the retainer to rotate, the retainer and the output shaft rotate synchronously, and the bearing roller pins serve as bearings; when the power output disc stops outputting power and the output shaft is active, the output shaft rotates to make the planes of the multi-surface shaft of the output shaft deflect, the assembling clearance of the locking roller pins between the output shaft and the fixing ring is eliminated, the output shaft is locked to the fixing ring accordingly, and the spindle is locked; in the locking process, under the supporting effect of the bearing roller pins, the spindle rotates in a balanced mode and is stressed uniformly, the locking reliability is high, and the whole structure assembling difficulty is low.

### BRIEF DESCRIPTION OF THE SEVERAL VIEWS OF THE DRAWINGS

For a clearer description of the embodiments of the invention or the technical schemes in the prior art, a simple illustration of the drawings required in the description of the embodiments or the prior art is given as follows, obviously, the drawings in the description are only used for illustrating certain embodiments of the invention, and for those skilled in the prior art, other drawings can be obtained according the following drawings without creative work.

FIG. 1 is a structure schematic diagram of a locking device for a spindle of an electric tool in an embodiment;

FIG. 2 is a breakdown structure schematic diagram of the locking device for the spindle of the electric tool in an embodiment;

FIG. 3 is an assembling schematic diagram of the cross section of the locking device for the spindle of the electric tool in an embodiment;

FIG. 4 is a cooperative schematic diagram of an output shaft, a retainer, self-locking roller pins, bearing roller pins and a fixing ring of the locking device for the spindle of the electric tool in an embodiment;

FIG. 5 is an assembling schematic diagram of the longitudinal section of the locking device for the spindle of the electric tool in an embodiment; and

FIG. 6 is a breakdown schematic diagram of the combinational relation of the output shaft assembled on the retainer and the power output disc of the locking device for the spindle of the electric tool in an embodiment.

Wherein: output shaft 10, multi-surface shaft 110, outer-diameter plane of multi-surface shaft 111, outer-diameter arc surface of multi-surface shaft 112, fixing ring 20, round through hole 210, retainer 30, axial through hole 310, first slot 320, second slot 330, insertion groove 340, locking roller pin 40, bearing roller pin 50, power output disc 60, center hole 610, sectorial convex part 620, convex column 630, electric tool shell 90.

### DETAILED DESCRIPTION OF THE INVENTION

For understanding the invention conveniently, a more comprehensive description of the invention is given with relevant accompanying drawings as follows. Preferred embodiments of the invention are given in the drawings. However, the invention can be realized in various different forms and is not limited to the embodiments in the description. On the contrary, the embodiments are provided for a more thorough and comprehensive understanding of the content disclosed by the invention.

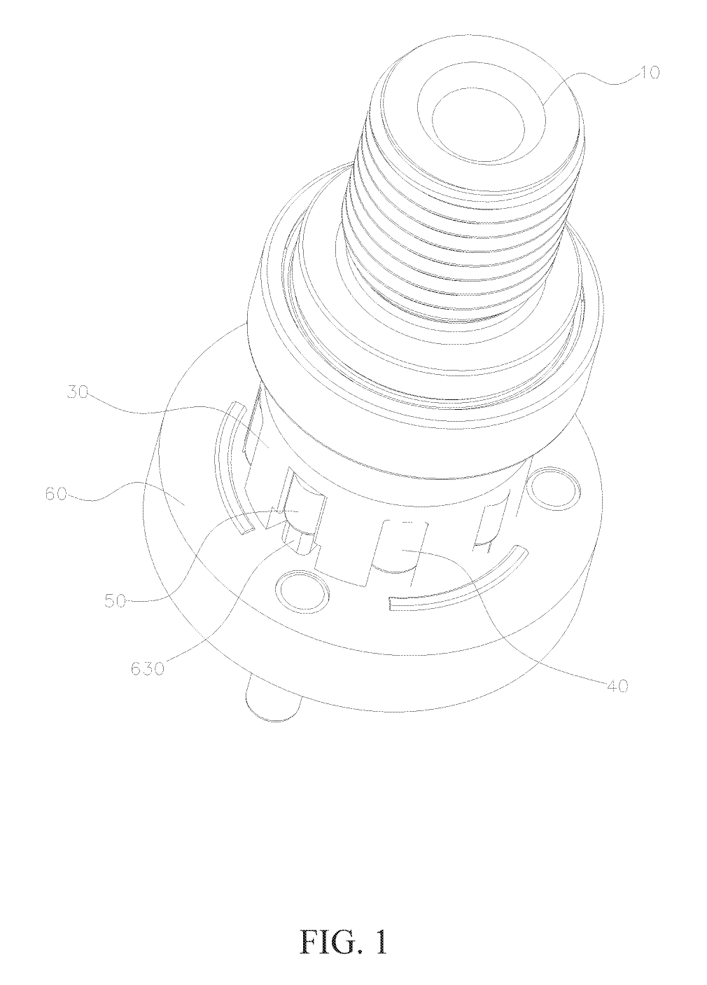

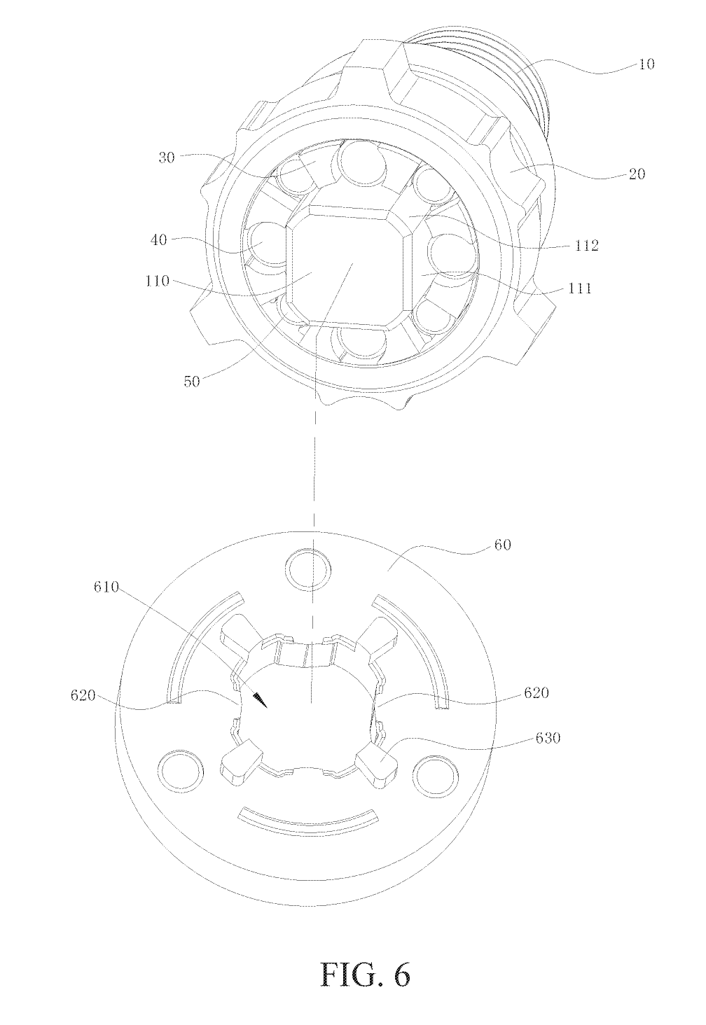

As is shown in FIGS. 1-6, a locking device for a spindle of an electric tool comprises:

an output shaft 10, wherein the output shaft is provided with a multi-surface shaft 110 with the outer-diameter portion being polygonal on the whole, every two adjacent planes 111 of the multi-surface shaft 110 are connected through arc surfaces 112 of the same circumference, and the arc surfaces 112 are concentric with the output shaft 10; the output shaft 10 is formed on the spindle of the electric tool and can also be the spindle of the electric tool; the planes 111 of the multi-surface shaft 110 can be formed through cutting from the axis of the cylindrical shaft, and the non-cut portions form the arc surfaces 112; of course, in other embodiments, the multi-surface shaft 110 can also be formed through casting or power die-casting or in other ways; the number of the outer-diameter planes 111 of the multi-surface shaft 110 is three or more;

a fixing ring 20, wherein the fixing ring 20 is fixedly connected to an electric tool shell 90 and provided with a round through hole 210; the fixing ring 20 is a component used for being mounted and fixed in the electric tool shell 90, and unnecessary details of the structure and the assembling principle of the fixing ring 20 are not given any more;

a retainer 30, wherein the retainer 20 is arranged in the round through hole 210 of the fixing ring 20 and provided with an axial through hole 310 allowing the multi-surface shaft 110 to be inserted therein, first slots 320 are formed in the positions, corresponding to the outer-diameter planes 111 of the multi-surface shaft 110, of the wall of the axial through hole 310 of the retainer 30, second slots 330 are formed in the positions, corresponding to the outer-diameter arc surfaces 112 of the multi-surface shaft 110, of the wall of the axial through hole 310, and insertion grooves 340 are formed in the end face of the retainer 30;

locking roller pins 40, wherein the locking roller pins 40 are contained in the first slots 320 and assembled between the outer-diameter planes 111 of the multi-surface shaft 110 and the inner wall of the round through hole 210 of the fixing ring 20 in a spaced mode; since the number of the outer-diameter planes 111 of the multi-surface shaft 110 is more than one, when the locking roller pins 40 are correspondingly assembled on the outer-diameter planes 111 of the multi-surface shaft 110 respectively, the number of the locking roller pins 40 is more than one; in addition, since the outer-diameter planes 111 of the multi-surface shaft 110 are arrayed in a regular polygon shape on the whole, the locking roller pins 40 are uniformly distributed on the periphery of the multi-surface shaft 110;

bearing roller pins 50, wherein the bearing roller pins 50 are contained in the second slots 330 and are in bearing fit with the outer-diameter arc surfaces 112 of the multi-surface shaft 110 and the round inner hole 210 of the fixing ring 20; since the multiple arc surfaces 112 of the multi-surface shaft 110 are connected between every two planes 111 of the multi-surface shaft 110, when the locking roller pins 40 are correspondingly assembled to the outer-diameter arc surfaces 112 of the multi-surface shaft 110 respectively, the number of the locking roller pins 40 is more than one; in addition, since the outer-diameter arc surfaces 112 of the multi-surface shaft 110 are distributed evenly, the locking roller pins 40 are uniformly distributed on the periphery of the multi-surface shaft 110; it should be understood that every two of the locking roller pins 40 and the bearing roller pins 50 are alternately distributed in a staggered mode;

and a power output disc 60, wherein the power output disc 60 is connected to an electric tool power system and provided with a center hole 610, sectorial convex parts 620 are arranged in the positions, corresponding to the outer-diameter planes 111 of the multi-surface shaft 110, of the inner wall of the center hole 610 in a protruding mode in the radial direction, convex columns 630 are arranged the end face, right facing the retainer 30, of the power output disc 60 in a protruding mode in the axial direction, and the convex columns 630 are matched with the insertion grooves 340 of the retainer 30.

The multi-surface shaft 110 of the output shaft 10 penetrates through the retainer 30 and is inserted into the center hole 610 of the power output disc 60, the retainer 30 is rotatably assembled in the round through hole 210 of the fixing ring 20 through the locking roller pins 40 and the bearing roller pins 50, and meanwhile, the convex columns 630 of the power output disc 60 can be inserted into the insertion grooves 340 of the retainer 30 so as to achieve insertion assembling.

In the operating process, when the locking device is used as an electric tool, namely when the power output disc 60 is active, the sectorial convex parts 620 of the power output disc 60 abut against the planes 111 of the multi-surface shaft 110 to drive the output shaft 10 to rotate, and thus torque is output. Meanwhile, the convex columns 630 of the power output disc 60 are matched with the insertion grooves 340 in an inserted mode to drive the retainer 30 to rotate, the retainer 30 and the output shaft 10 rotate synchronously, and in the process, the bearing roller pins 50 serve as roller pins of bearings between the output shaft 10 and the fixing ring 20.

When the locking device is used as a manual tool, namely when the power output disc 60 stops outputting power and the output shaft 10 is active, the output shaft 10 rotates to make the planes 111 of the multi-surface shaft 110 of the output shaft 10 deflect, the assembling clearance of the locking roller pins 40 between the output shaft 10 and the fixing ring 20 is eliminated, the output shaft 10 is locked to the fixing ring 20 accordingly, and thus the spindle is locked.

In the locking process, since the bearing roller pins 50 are used for supporting between the output shaft 10 and the fixing ring 20 all the time, the concentricity of the output shaft 10 and the fixing ring 20 is guaranteed, and thus the spindle can rotate in a balanced mode; all the locking roller pins 40 are driven to abut against the fixing ring 20 in the locking process, the spindle is stressed uniformly, the locking reliability is high, and the overall structure assembling difficulty is low.

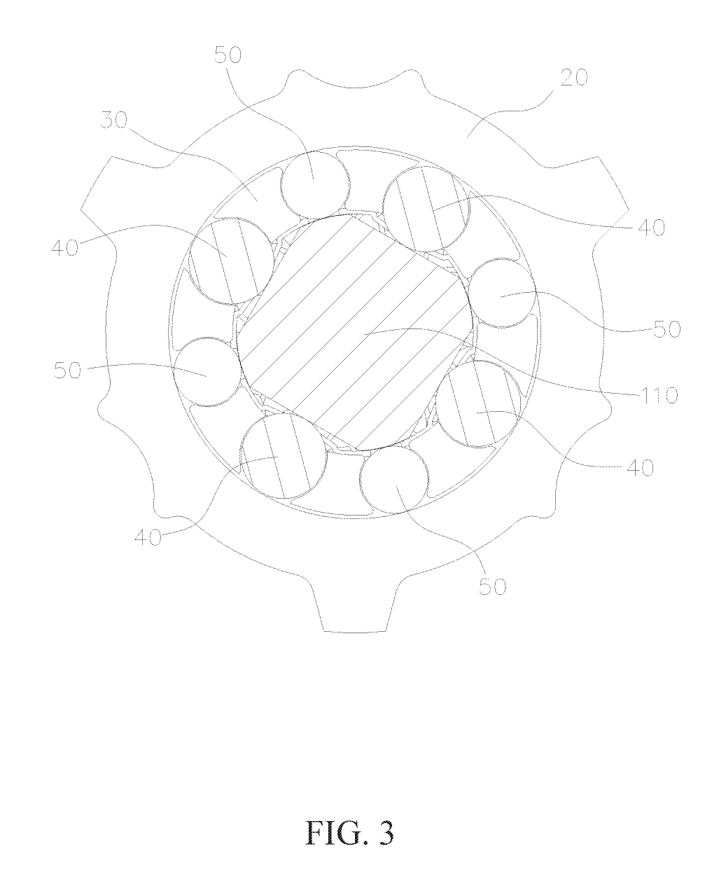

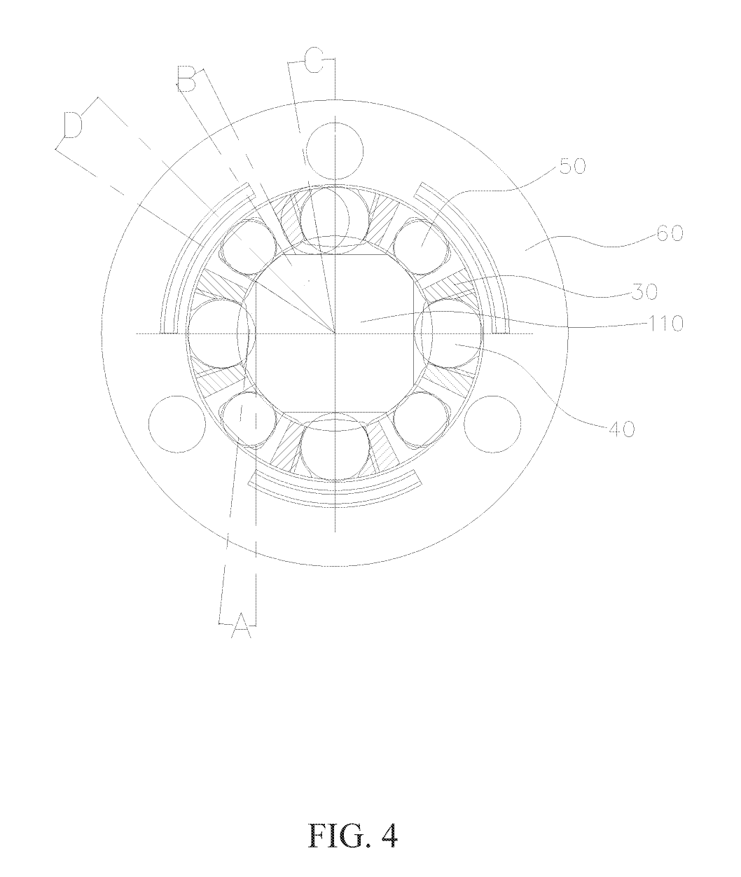

As is shown in FIGS. 3-4, in an embodiment:

when the power output disc 60 rotates automatically until the sectorial convex parts 620 abut against the outer-diameter planes 111 of the multi-surface shaft 110 to drive the output shaft 10, the maximum rotation angle of the power output disc 60 relative to the output shaft 10 is A;

when the power output disc 60 rotates automatically until the convex columns 630 abut against the side walls of the insertion grooves 340 of the retainer 30 to drive the retainer 30, the maximum rotation angle of the power output disc 60 relative to the retainer 30 is B;

when the output shaft 10 actively rotates until the outer-diameter planes 111 of the multi-surface shaft 110 squeeze the locking roller pins 40 onto the fixing ring 20 to be locked, the maximum rotation angle of the output shaft 10 relative to the fixing ring 20 is C;

half of the arc angle of each outer-diameter arc surface 112 of the multi-surface shaft 110 is D;

According to the relations of the above angles: A<(B+C), C<(A+B), and A<D.

Please see FIG. 4, in an embodiment, the angle A is equal to the angle B.

In an embodiment, the sum of the radius of the multi-surface shaft 110 and the diameter of each bearing roller pin 50 is not smaller than the sum of the distance from each outer-diameter plane 111 to the center of the multi-surface shaft 110 and the diameter of each self-locking roller pin. Please see FIG. 3, the longer the chords of the outer-diameter arc surfaces 112 of the multi-surface shaft 110 are, the longer the corresponding arcs are, and the larger the contact areas between the arc surfaces 112 and the bearing roller pins 50 are, otherwise, the contact areas between the arc surfaces 112 and the bearing roller pins 50 are smaller. Similarly, the larger the side lengths of the outer-diameter planes 111 of the multi-surface shaft 110 are, the larger the contact areas between the planes 111 and the locking roller pins 40 are, and otherwise, the contact areas between the planes 111 and the locking roller pins 40 are smaller. When the spindle is active, the retainer 30 is inserted into the power output disc 60 to stop rotating, the output shaft 10 and the retainer 30 cannot rotate synchronously, so that when the output shaft 10 rotates, the multi-surface shaft 110 of the output shaft 10 rotates relative to the retainer 30, and the outer-diameter planes 111 of the multi-surface shaft 110 deflect relative to the locking roller pins 40. If the ratio of the chord lengths of the outer-diameter arc surfaces 112 of the multi-surface shaft 110 to the side lengths of the outer-diameter planes 111 of the multi-surface shaft 110 is too large, the side lengths of the outer-diameter planes 111 are too small, the outer-diameter planes 111 are unavoidably out of the contact areas with the locking roller pins 40 when deflecting relative to the locking roller pins 40, the edges, intersecting with the arc surfaces 112, of the outer-diameter planes 111 of the multi-surface shaft 110 are made to abut against the locking roller pins 40, and consequentially unnecessary abrasion of the locking roller pins 40 is caused. If the ratio of the chord lengths of the outer-diameter arc surfaces 112 of the multi-surface shaft 110 to the side lengths of the outer-diameter planes 111 of the multi-surface shaft 110 is too small, the arc lengths of the outer-diameter arc surfaces 112 of the multi-surface shaft 110 is too small, the outer-diameter arc surfaces 112 of the multi-surface shaft 110 are unavoidably out of the contact areas with the bearing roller pins 50 when deflecting, and consequentially the bearing roller pins 50 fail to achieve the bearing supporting function. On this basis, the sum of the radius of the multi-surface shaft 110 and the diameter of each bearing roller pin 50 is selectively not to be smaller than the sum of the distance from each outer-diameter plane 111 to the center of the multi-surface shaft 110 and the diameter of each self-locking roller pin.

Please see FIG. 3, in an embodiment, the ratio of the section circumferential radius of the multi-surface shaft 110 to the radius of each bearing roller pin 50 is not smaller than 2.5:1. Theoretically, the sum of the section circumferential diameter of the multi-surface shaft 110 and the diameter of each bearing roller pin 50 is equal to the inner diameter of the fixing ring 20; when the section circumferential diameter of the multi-surface shaft 110 is smaller relative to the diameter of the fixing ring 20, the concentricity error between the multi-surface shaft 110 and the fixing ring 20 is increased more easily due to assembling errors and abrasion after long-time use, on this basis, the ratio of the section circumferential radius of the multi-surface shaft 110 to the radius of each bearing roller pin 50 is selectively not smaller than 2.5:1, so that the concentricity between the multi-surface shaft 110 and the fixing ring 20 in the assembling and using processes is guaranteed, and the locking reliability is improved.

In an embodiment, the number of the outer-diameter planes 111 of the multi-surface shaft 110 is an even number. When the number of the outer-diameter planes 111 of the multi-surface shaft 110 is an even number, the number of the arc surfaces 112 connected between every two planes 111 is also an even number, so that it is guaranteed that two opposite bearing roller pins 50 exist on each diameter of the multi-surface shaft 110, and the bearing roller pins 50 can support the multi-surface shaft 110 more uniformly.

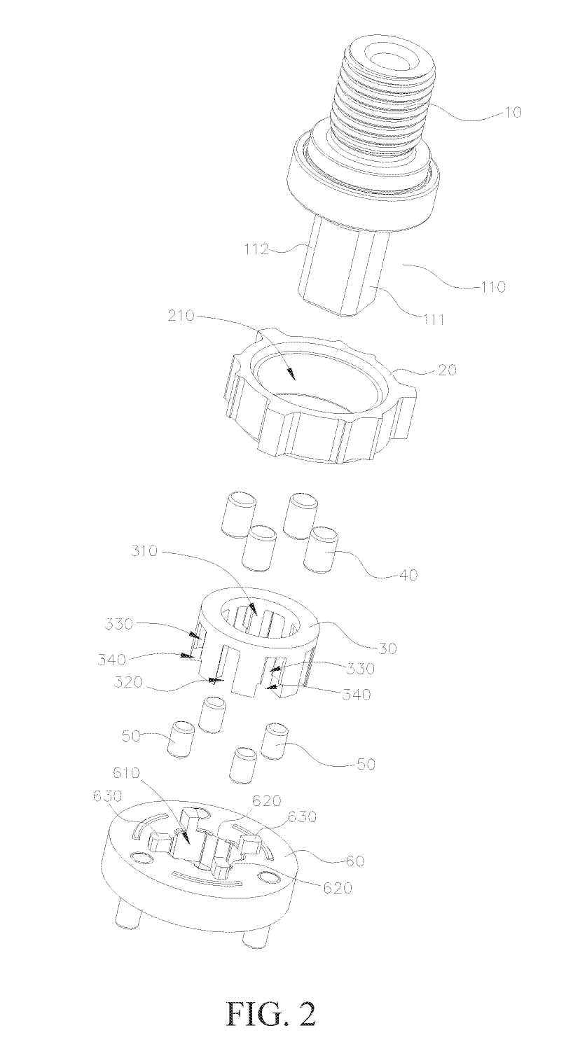

In the specific embodiment shown in FIGS. 2-3, the number of the outer-diameter planes 111 of the multi-surface shaft 110 is four, and the arc angle of each outer-diameter arc surface 112 of the multi-surface shaft 110 is smaller than 45 degrees and larger than 20 degrees.

As is shown in FIG. 3, in an embodiment, the retainer 30 is in interference fit with the fixing ring 20 and is in clearance fit with the output shaft 10. In this way, a large static friction force can exist between the retainer 30 and the fixing ring 20, and the locking effect can be further guaranteed when the output shaft 10 is active. The retainer 30 is in clearance fit with the output shaft 10, so that the power output smoothness is guaranteed when the power output disc 60 is active to serve as an electric tool.

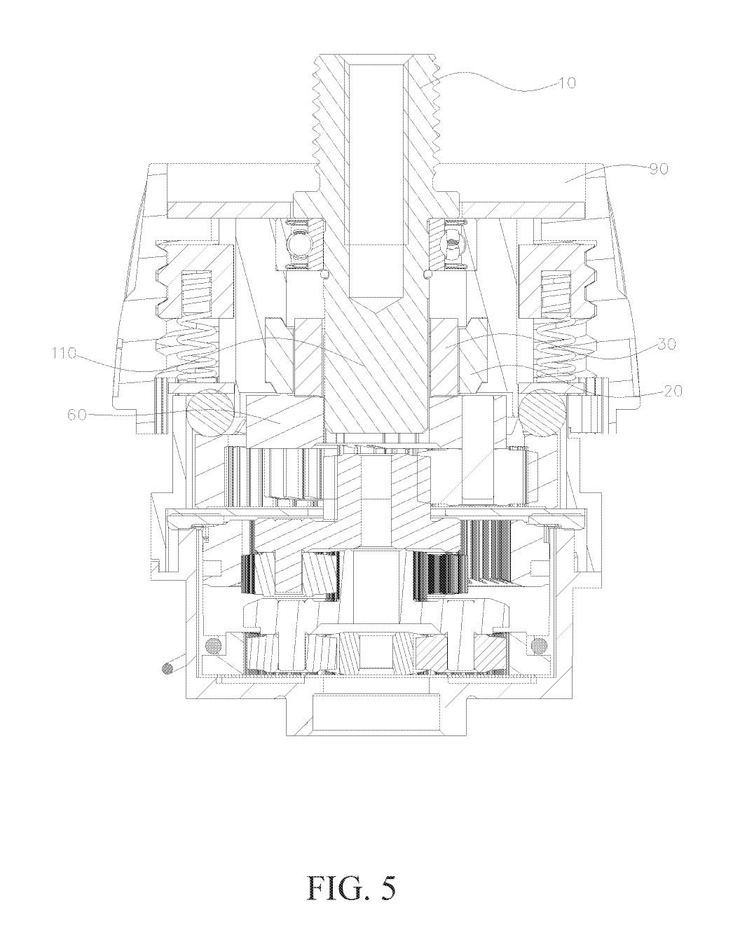

As is shown in FIG. 2 and FIG. 5, in an embodiment, the insertion grooves 340 are formed in the ends, right facing the power output disc 60, of the first slots 320 and/or the second slots 330. In this way, the insertion grooves 340 and the second slots 330 can share positions, on the one hand, the assembling space in the electric tool can be narrowed easily, and on the other hand, when the convex columns 630 of the power output disc 60 are inserted into the insertion grooves 340, the bearing roller pins 50 can be restrained in the second slots 330, and the assembling reliability is improved.

In an embodiment, the width of each insertion groove 340 is not smaller than the diameter of the corresponding first slot 320 or the corresponding second slot 330 so that the locking roller pins 40 or the bearing roller pins 50 can be uniformly and completely limited in the first slots 320 or the second slots 330 after the convex columns 630 are inserted into the insertion grooves 340.

The above embodiments only describe several execution modes of the invention and are specifically described in detail, however, the patent scope of the invention is not limited to the above embodiments. It should be pointed out that for those skilled in the field, various transformations and improvements can be made without deviating from the concept of the invention, and all the transformations and improvements are within the protection scope of the invention. Therefore, the protection scope of the invention is subject to the attached claims.

What is claimed is:

1. A locking device for a spindle of an electric tool, comprising:
an output shaft, wherein the output shaft is provided with a multi-surface shaft with the outer-diameter portion being polygonal on the whole, every two adjacent planes of the multi-surface shaft are connected through arc surfaces of the same circumference, and the arc surfaces are concentric with the output shaft;
a fixing ring, wherein the fixing ring is fixedly connected to an electric tool shell and provided with a round through hole;
a retainer, wherein the retainer is arranged in the round through hole of the fixing ring and provided with an axial through hole allowing the multi-surface shaft to be inserted therein, first slots are formed in the positions, corresponding to the outer-diameter planes of the multi-surface shaft, of the wall of the axial through hole of the retainer, second slots are formed in the positions, corresponding to the outer-diameter arc surfaces of the multi-surface shaft, of the wall of the axial through hole, and insertion grooves are formed in the end face of the retainer;
locking roller pins, wherein the locking roller pins are contained in the first slots and assembled between the outer-diameter planes of the multi-surface shaft and the inner wall of the round through hole of the fixing ring in a spaced mode;
bearing roller pins, wherein the bearing roller pins are contained in the second slots and are in bearing fit with the outer-diameter arc surfaces of the multi-surface shaft and the round through hole of the fixing ring;
and a power output disc, wherein the power output disc is connected to an electric tool power system and provided with a center hole, sectorial convex parts are arranged in the positions, corresponding to the outer-diameter planes of the multi-surface shaft, of the inner wall of the center hole in a protruding mode in the radial direction, convex columns are arranged the end face, right facing the retainer, of the power output disc in a protruding mode in the axial direction, and the convex columns are matched with the insertion grooves of the retainer.

2. The locking device for the spindle of the electric tool according to claim 1, characterized in that:
when the power output disc rotates automatically until the sectorial convex parts abut against the outer-diameter planes of the multi-surface shaft to drive the output shaft, the maximum rotation angle of the power output disc relative to the output shaft is A;
when the power output disc rotates automatically until the convex columns abut against the side walls of the insertion grooves of the retainer to drive the retainer, the maximum rotation angle of the power output disc relative to the retainer is B;
when the output shaft actively rotates until the outer-diameter planes of the multi-surface shaft squeeze the locking roller pins onto the fixing ring to be locked, the maximum rotation angle of the output shaft relative to the fixing ring is C;
half of the arc angle of each outer-diameter arc surface of the multi-surface shaft is D;
A<(B+C), C<(A+B), and A<D.

3. The locking device for the spindle of the electric tool according to claim 1, characterized in that the angle A is equal to the angle B.

4. The locking device for the spindle of the electric tool according to claim 2, characterized in that the sum of the radius of the multi-surface shaft and the diameter of each bearing roller pin is not smaller than the sum of the distance from each outer-diameter plane to the center of the multi-surface shaft and the diameter of each self-locking roller pin.

5. The locking device for the spindle of the electric tool according to claim 4, characterized in that the ratio of the section circumferential radius of the multi-surface shaft to the radius of each bearing roller pin is not smaller than 2.5:1.

6. The locking device for the spindle of the electric tool according to claim 1, characterized in that the number of the outer-diameter planes of the multi-surface shaft is an even number.

7. The locking device for the spindle of the electric tool according to claim 6, characterized in that the number of the outer-diameter planes of the multi-surface shaft is four, and the arc angle of each outer-diameter arc surface of the multi-surface shaft is smaller than 45 degrees and larger than 20 degrees.

8. The locking device for the spindle of the electric tool according to claim 2, characterized in that the retainer is in interference fit with the fixing ring and is in clearance fit with the output shaft.

9. The locking device for the spindle of the electric tool according to any claim 1, characterized in that the insertion grooves are formed in the ends, right facing the power output disc, of the first slots and/or the second slots.

10. The locking device for the spindle of the electric tool according to claim 9, characterized in that the width of each insertion groove is not smaller than the diameter of the corresponding first slot or the corresponding second slot.
